(19) United States
(12) Patent Application Publication
(10) Pub. No.: US 2014/0088965 A1
(43) Pub. Date: Mar. 27, 2014

(54) ASSOCIATING AND LOCATING MOBILE STATIONS BASED ON SPEECH SIGNATURES

(71) Applicant: POLARIS WIRELESS, INC., Mountain View, CA (US)

(72) Inventor: Narender Goel, Mountain View, CA (US)

(73) Assignee: POLARIS WIRELESS, INC., Mountain View, CA (US)

(21) Appl. No.: 13/628,486

(22) Filed: Sep. 27, 2012

(51) Int. Cl. G10L 17/00

(52) U.S. Cl. 704/246; 704/E17.001

(57) ABSTRACT

Methods and systems populate a speech signature database with unique speech signatures that are associated with one or more speaker identities and are further associated with one or more mobile stations and/or telephone numbers. Real-time voice signals are compared to the speech signatures in the speech signature database. When a match is found, the mobile station from which the voice signal originated is located in real-time. Further, the associations in the speech signature database are leveraged to find other relevant mobile stations or users and to generate additional associations and to also locate associated users and mobile stations.

### FIELD OF THE INVENTION

The present invention relates to wireless networks in general, and, more particularly, to location-based services.

### BACKGROUND OF THE INVENTION

FIG. 1 depicts a diagram of the salient components of a portion of typical wireless telecommunications network 100 in the prior art. Wireless telecommunications network 100 comprises: mobile stations 101 and 110, cellular base stations 102-i, e.g., 1024, 102-2, and 102-3, Wi-Fi base stations 103-j, e.g., 103-1 and 103-2, wireless switching center 111, and wireless location system 112. Wireless telecommunications network 100 provides wireless telecommunications service to all mobile stations within its coverage area, in well-known fashion. Telecommunications network 120, which is well-known in the art as a general-purpose telecommunications network, e.g., the Public Switched Telephone Network, is also depicted in FIG. 1, but is not part of wireless network 100, Global Positioning System (“GPS”) constellation 121, which is well-known in the art, is also depicted in FIG. 1, but is not part of wireless network 100.

Surveillance system 130, which is well-known in the art, is also depicted but is not part of wireless network 100. Typically, a given mobile station is known to be used by a “person of interest,” i.e., a terrorist, a criminal, a suspect, a missing person. Surveillance system 130 enables law enforcement to request the current location of the given (known) mobile station that is under surveillance with respect to the person of interest. Location data for the given mobile station is received by surveillance system 130 from GPS constellation 121 and/or wireless location system 112 according to techniques that are well known in the art.

However, the advantages of mobility and relative anonymity provided by today's wireless mobility become a detriment when investigating crimes, threats, terrorism, and missing persons. As is well known in the art, mobile stations are widely available for purchase on pre-paid plans such that the personal identity of the user remains unknown to the wireless service provider. Moreover, mobile stations accommodate so-called removable SIM cards (subscriber identity module or subscriber identification module) so that a user can in effect change the identity of the mobile station with each successive SIM card. Each SIM card has a unique International Mobile Subscriber Identity (“IMSI”) that is reported by the mobile station when in service with the respective SIM card. Thus, a user can easily elude law enforcement by acquiring and using a succession of SIM cards or pre-paid mobile stations without revealing the user's personal identity to the service provider.

While these products and techniques provide a great deal of convenience and flexibility to ordinary users (e.g., using one SIM card for domestic personal calls, another one for international calls, and yet another for business), they provide law enforcement authorities with significant obstacles when using surveillance system 130.

### SUMMARY OF THE INVENTION

A major drawback of the prior art scenarios described above is that they presuppose that the surveilling entity possesses the identity of the mobile station used by the person of interest, e.g., a suspect is known to call from a certain telephone number or mobile station/SIM with a unique IMSI. As explained, this is not always so. The present inventor understood that one way to overcome this critical drawback is to rely on the unique speech signature of each mobile user to recognize the user's identity, and, in real-time determine if the user is a person of interest. Speech signatures are sometimes referred to as “voice prints.”

When the user turns out to be a person of interest, the mobile station can be immediately located. Law enforcement can then take appropriate action, e.g., apprehending a suspect, rescuing a missing person, establishing a safety perimeter, etc. Also, the illustrative embodiment can filter out calls with a speech signature that is not of interest, e.g., a suspect's child, and optionally forego or refrain from locating the mobile station. Thus, analyzing speech signatures before pro-actively locating a mobile station can provide an advantageous performance boost.

Although speaker recognition techniques based on voice print matching are well known in the art, (see, e.g., U.S. Pat. No. 8,155,394 B2 to Allegro et al., which is incorporated herein by reference), the present invention goes well beyond mere speaker recognition. The illustrative embodiment goes further to enrich the body of information that is available for the real-time identification and location efforts. The illustrative embodiment populates a speech signature database with a number of associations gleaned from calls that traverse a monitored network (wireless or otherwise). For example, when receiving a speaker's voice signal (e.g., from a person of interest or a pool of possible suspects, from a tapped telephone line, from a tapped mobile station, from a recording, etc.), a speech signature is computed and stored in the speech signature database. Also, the speech signature becomes associated with one or more identifiers. The associated identifiers include, for example and without limitation, the speaker's name or alias, the telephone number from which the voice signal was gleaned, and, for mobile stations, the IMSI of the mobile station (or SIM card) from which the voice signal was gleaned. Of course, the speaker's name or alias is not always known, and therefore the other associations that are generated can prove fruitful.

After this initial process, the speech signature is further analyzed against the other contents of the speech signature database. When a match is found in the speech signature database, more associations are generated. For example, the matching speech signature might have a different personal identity (name and/or alias) in the speech signature database than the present speaker's name, or perhaps the present speaker's name is unknown; if so, association(s) are created with those different personal identities, suggesting that the present speaker is the same person as the name/alias in the speech signature database. For example, the matching speech signature might have one or more different telephone numbers than the present speaker's telephone number; if so, association(s) are created with those other telephone numbers, suggesting that the present speaker has used several different telephone accounts over time. For example, the present telephone number becomes associated with other telephone numbers in the speech signature database. Likewise, the matching speech signature might have one or more different mobile station identifiers (e.g., IMSI) than the present speaker's IMSI; if so, association(s) are created with those other identifiers, suggesting that the present speaker used several different mobile stations and/or SIM cards over time.

Secondary associations or chained associations are further generated to describe inter-relationships among speakers and mobile stations as collected over the course of time. All these new associations become part of the speech signature database and greatly enrich the investigatory resources available for real-time identification and location efforts.

Later, when monitoring for persons of interest, each call that generates voice signals to/from one or more monitored base stations is analyzed for a matching speech signature in the speech signature database. When a match is found, the associations stored in the speech signature database may present useful relationships that can be leveraged to locate one or more mobile stations in real-time. For instance, recognizing a mobile user's speech signature may cause not only the present mobile station to be immediately located, but may also cause other previously-associated mobile stations to be located on the theory that the present user has used them in the past and they may be currently in the hands of accomplices. Even when the mobile station is flagged as a station of interest, which ordinarily causes the station to be located, the illustrative embodiment does not merely stop there; rather, by recognizing the present user's speech signature, the system again leverages the associations in the speech signature database to find other mobile stations that the present user has previously used and cause them to be located too. Further, when a name and/or alias is associated with the speech signature in the speech signature database, but the name/alias was not previously known to use the present mobile station, the speech signature database is updated with the new association between the present mobile and the known name/alias; in this way, the illustrative embodiment “puts a name to a number.”

The illustrative embodiment comprises a speaker recognition system that executes and coordinates the illustrative methods herein, a data store for the speech signature database, and network probe units that monitor the communication links to/from the base stations that cover a monitored geographic area. It will be clear to those having ordinary skill in the art, after reading the present disclosure, how to make and use other embodiments that are differently configured, optioned, and arranged, yet still fall well within the scope of the present invention.

A method according to the illustrative embodiment comprises: when a first measure of correlation as between (i) a first speech signature of a first voice signal from a first mobile station and (ii) a second speech signature of a second voice signal exceeds a first threshold, generating, by a speaker-recognition system, an association between the first mobile station and a second mobile station that is associated with the second speech signature, wherein the first mobile station is different from the second mobile station.

Another method according to the illustrative embodiment comprises:

computing, by a speaker-recognition system, a first speech signature of a first voice signal from a first mobile station; and

when the first speech signature matches a second speech signature of a second voice signal, transmitting, by the speaker-recognition system, a request for a location of the first mobile station.

A system according to the illustrative embodiment comprises:

a receiver for receiving a first voice signal from a first mobile station; and
a processor configured to:
determine whether a first speech signature of the first voice signal matches a second speech signature of a second voice signal,
when the first speech signature matches the second speech signature, generate at least one of:
(i) an association between the first mobile station and a second mobile station that is associated with the second speech signature, wherein the first mobile station is different from the second mobile station,
(ii) an association between the first mobile station and a speaker having the second speech signature,
(iii) an association between a first user of the first mobile station and the speaker having the second speech signature,
(iv) an association between the first user of the first mobile station and the second mobile station, and
(v) an association between a telephone number associated with the first mobile station and the second speech signature.

### BRIEF DESCRIPTION OF THE DRAWINGS

FIG. 1 depicts a diagram of the salient components of a portion of typical wireless telecommunications network 100 in the prior art.

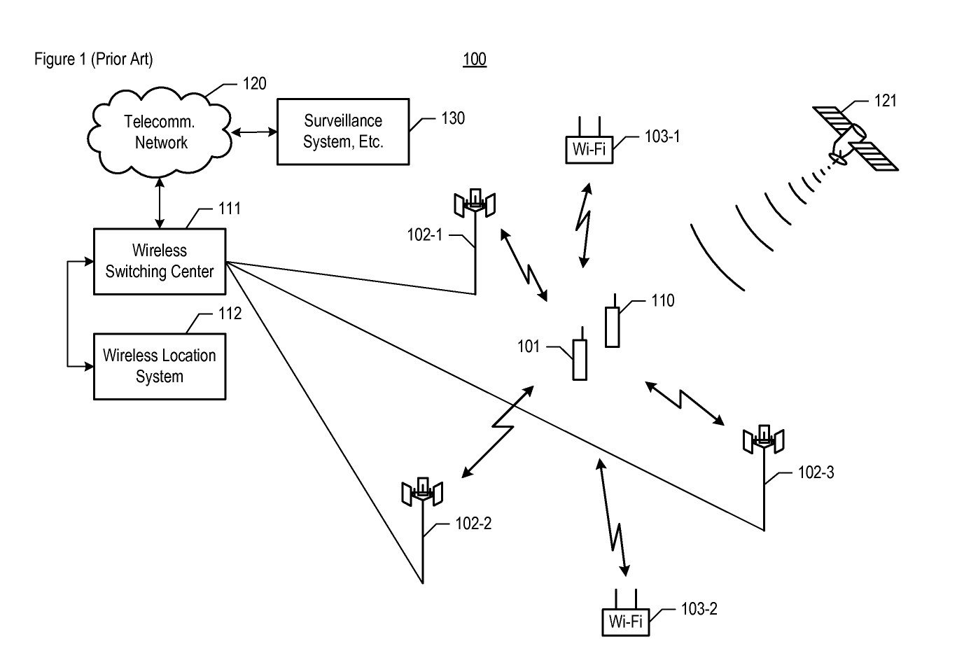

FIG. 2 depicts a diagram of the salient components of a portion of wireless telecommunications network 200 according to an illustrative embodiment of the present invention.

FIG. 3 depicts a block diagram of the salient components of speaker recognition system 213 in accordance with the illustrative embodiment.

FIG. 4 depicts a block diagram of the salient components of data store 214 in accordance with the illustrative embodiment.

FIG. 5 depicts a flowchart of the salient operations of method 500 according to the illustrative embodiment of the present invention.

FIG. 6A depicts a flowchart of the salient sub-operations of operation 501 according to the illustrative embodiment of the present invention.

FIG. 6B depicts a flowchart of the salient sub-operations of operation 511 according to the illustrative embodiment of the present invention.

FIG. 7 depicts a flowchart of the salient sub-operations of operation 601 according to the illustrative embodiment of the present invention.

FIG. 8 depicts a flowchart of the salient sub-operations of operation 603 according to the illustrative embodiment of the present invention.

FIG. 9 depicts a flowchart of the salient sub-operations of operation 617 according to the illustrative embodiment of the present invention.

FIG. 10A depicts a flowchart of the salient sub-operations of a first part of operation 619 according to the illustrative embodiment of the present invention.

FIG. 10B depicts a flowchart of the salient sub-operations of a second part of operation 619 according to the illustrative embodiment of the present invention.

### DETAILED DESCRIPTION

For the purposes of this specification, the following terms and their inflected forms are defined as follows:
The term “location” is defined as any one of a zero-dimensional point, a one-dimensional line, a two-dimensional area, or a three-dimensional volume. Thus, a location can be described, for example, by a street address, geographic coordinates, a perimeter, a geofence, a cell ID, or an enhanced cell ID.
The term “geofence” is defined as a virtual perimeter surrounding a geographic area.
The term “mobile station” is defined as an apparatus that:
   receives signals from another apparatus without a wire, or
   transmits signals to another apparatus without a wire, or
   both (i) and (ii).
This term is used synonymously herein with the following terms: wireless terminal, wireless telecommunications terminal, user equipment, mobile terminal, mobile station, mobile handset, and mobile unit.
For the convenience of the reader, the term “speaker” is used herein to refer to a person who has a previously-stored speech signature residing in the speech signature database; a speaker is associated with a speech signature in the speech signature database. In contrast, the term “user” is used herein to generally refer to a person who is actively using a mobile station and whose real-time voice signal, when analyzed, may cause the mobile station to be located. Thus an incoming speech signature based on a real-time voice signal from a “user” may be compared against a stored speech signature of a “speaker.”

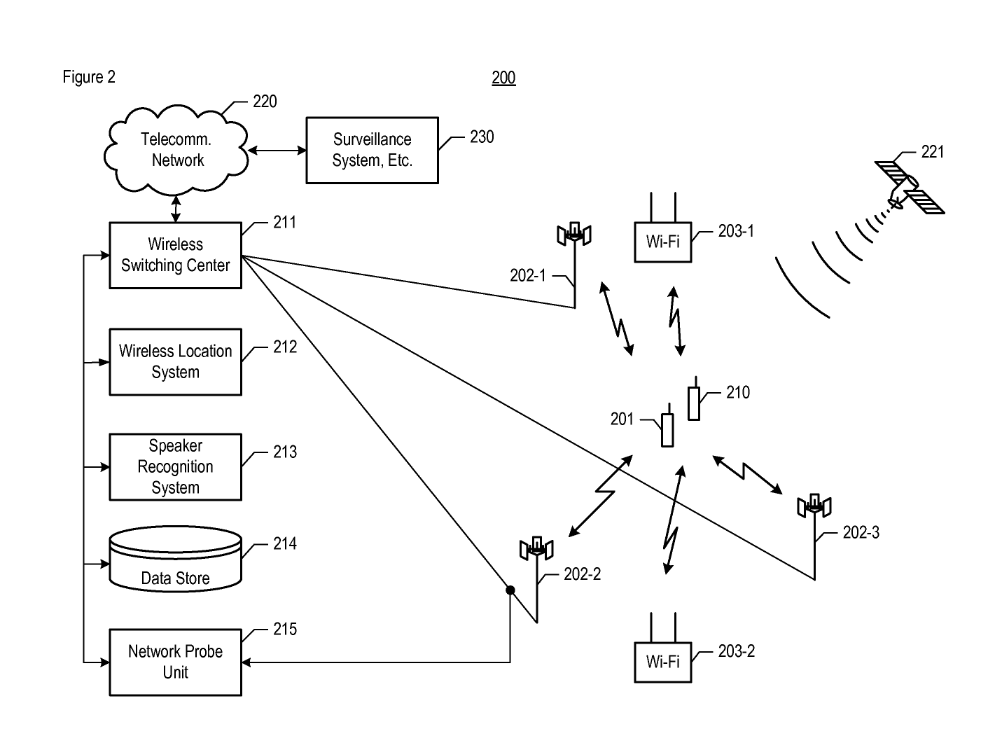

FIG. 2 depicts a diagram of the salient components of a portion of wireless telecommunications network 200 according to the illustrative embodiment of the present invention. Wireless network 200 comprises mobile stations 201 and 210, cellular base stations 202-i, e.g., 202-1, 202-2, and 202-3, Wi-Fi base stations 203-j, e.g., 203-1 and 203-2, wireless switching center 211, location system 212, speaker recognition system 213, data store 214, and network probe unit 215, which are interrelated as shown. Wireless network 200 provides wireless telecommunications service to all mobile stations within its coverage area, including mobile stations 201 and 210, in well-known fashion; in addition, speaker recognition system 213 performs and coordinates the operations as described in more detail below, based in part on telecommunicating with data store 214. Telecommunications network 220, which is well known in the art, is also depicted but is not part of wireless network 200. Global Positioning System (“GPS”) constellation 221, which is well known in the art, is also depicted in FIG. 2, but is not part of wireless network 200. Surveillance system 230 is also depicted but is not part of wireless network 200. Other external systems also are connected to speaker recognition system 213 via telecommunications network 220 but are not expressly depicted in FIG. 2, e.g., a surveillance database, a criminal records system, a terrorism tracking system, a criminal/terrorist suspects' database, etc., without limitation.

In accordance with the illustrative embodiment, wireless telecommunications service is provided to mobile stations 201 and 210 (whether at the same time or at different times) in accordance with the air-interface standard of the 3rd Generation Partnership Project (“3GPP”). Examples of 3GPP air-interface standards include GSM, UMTS, and LTE. After reading this disclosure, however, it will be clear to those skilled in the art how to make and use alternative embodiments of the present invention that operate in accordance with one or more other air-interface standards (e.g., CDMA-2000, IS-136 TDMA, IS-95 CDMA, 3G Wideband CDMA, IEEE 802.11 Wi-Fi, 802.16 WiMax, Bluetooth, etc.) in one or more frequency bands. It will be clear to those having ordinary skill in the art how to recognize and implement the corresponding terms, if any, for non-3GPP types of wireless networks with respect to other embodiments of the present invention.

Mobile stations 201 and 210 each comprises the hardware and software necessary to be 3GPP-compliant, to make and receive voice calls, and to perform the processes described below and in the accompanying figures in accordance with the illustrative embodiment. Mobile stations 201 and 210 are mobile. For example and without limitation, mobile stations 201 and 210 each is capable of:
transmitting one or more signals, including voice signals, to cellular base stations 202-i and Wi-Fi base stations 203-j, including reports of telecommunications events experienced by the respective mobile station, such as call originations and call terminations (received), and
receiving service from one or more of cellular base stations 202-i and Wi-Fi base stations 203-j, including voice signals from other parties, and
measuring one or more traits of each of one or more electromagnetic signals (received from cellular base stations 202-i and/or Wi-Fi base stations 203-j) and of reporting the measurements to wireless location system 212.

Illustrative examples of salient telecommunications events that are experienced and reported by mobile stations 201 and/or 210 include without limitation:
a. an origination of a voice call by the mobile station,
b. a receiving of a voice call by the mobile station (sometimes referred to as “call termination”),
c. an establishment of a voice call between the mobile station and another telecommunications terminal, whether in the network or elsewhere, i.e., establishing a call connection.

Mobile stations 201 and 210 each is illustratively a smartphone with both voice and data service provided and supported by wireless network 200 (whether both terminals are active at the same time or at different times). It will be clear to those having ordinary skill in the art, after reading the present disclosure, how to make and use wireless network 200 with mobile station 201 that is a cell phone, a data tablet, or a combination thereof. It will be clear to those having ordinary skill in the art, after reading the present disclosure, how to make and use wireless network 200 with mobile station 210 that is a cell phone, a data tablet, or a combination thereof. Mobile stations 201 and 210 are illustratively in service at the same time, but need not be. It will be clear to those skilled in the art, after reading this disclosure, how to make and use alternative embodiments of the present invention that comprise any number of mobile stations supported by wireless network 200.

Cellular base stations 202-i comprise the hardware and software necessary to be 3GPP-compliant according to the illustrative embodiment and they are well known in the art. For example and without limitation, cellular base stations 202-i are each capable of:
measuring one or more traits of each of one or more electromagnetic signals (transmitted by mobile station 201 and mobile station 210), and reporting the measurements to location system 212,
detecting one or more of the telecommunications events occurring at mobile station 201 and mobile station 210, and
transmitting one or more signals, and reporting the transmission parameters of those signals, and reporting telecommunications events to location system 212, and
reporting on the above-enumerated telecommunications events associated with a mobile station.

Cellular base stations 202-i communicate with wireless switching center 211 by wire, and with mobile stations 201 and 210 via radio frequencies (“RF”) in well-known fashion. As is well known to those skilled in the art, base stations are also commonly referred to by a variety of alternative names such as access points, nodes, network interfaces, cell sites, etc. Although the illustrative embodiment comprises three base stations, it will be clear to those skilled in the art, after reading the present disclosure, how to make and use alternative embodiments that comprise any number of base stations 202-i.

Wi-Fi base stations 203-j comprise the hardware and software necessary to be 3GPP-compliant according to the illustrative embodiment and they are well known in the art. Wi-Fi base stations 203-j are each capable of, without limitation:
measuring one or more traits of each of one of more electromagnetic signals (transmitted by mobile station 201 and mobile station 210), and reporting the measurements to location system 212, and
detecting one or more of the telecommunications events occurring at mobile station 201 and mobile station 210, and
transmitting one or more signals, and reporting the transmission parameters of those signals, and reporting telecommunications events to location system 212, and
reporting on the above-enumerated telecommunications events associated with a mobile station.

Wi-Fi base stations 203-j communicate with mobile stations 201 and 210 via radio frequencies (“RF”) in well-known fashion (whether at the same time or at different times). Wi-Fi base stations 203-j have a shorter range than cellular base stations 202-i, but sometimes have a higher bandwidth.

Wireless switching center 211, comprises a switch that orchestrates providing telecommunications service to mobile stations 201 and 210 and the flow of information to/from other elements of wireless network 200, e.g., location system 212, speaker recognition system 213, data store 214, and one or more network probe units like network probe unit 215 as described below and in the accompanying figures. It will be clear to those having ordinary skill in the art, after reading the present disclosure, how to make and user alternative embodiments where the flow of information among the above-mentioned elements is differently controlled and/or differently routed, or is accomplished through direct connections between the respective elements.

As is well known to those skilled in the art, wireless switching centers are also commonly referred to by other names such as mobile switching centers, mobile telephone switching offices, routers, packet data service nodes, GPRS support nodes, or a combination thereof, etc. Although the illustrative embodiment comprises one wireless switching center, it will be clear to those skilled in the art, after reading this disclosure, how to make and use alternative embodiments of the present invention that comprise any number of wireless switching centers. In accordance with the illustrative embodiment, all of the base stations servicing mobile stations 201 and 210 are associated with wireless switching center 211. It will be clear to those skilled in the art, after reading this disclosure, how to make and use alternative embodiments of the present invention in which any number of base stations are associated with any number of wireless switching centers.

Location system 212 comprises hardware and software that estimates one or more locations for mobile stations 201 and 210 (and for any terminal served by wireless network 200). Preferably, location system 212 is a mass location system that provides real-time location data on demand, e.g., when speaker recognition system 213 so requests. According to the illustrative embodiment, location system 212 is the OmniLocate™ wireless location platform product from Polaris Wireless, Inc. OmniLocate is a mass location system that estimates a location that is associated with telecommunications events, including call origination from and call termination to mobile stations 201 and 210. OmniLocate provides location capabilities across 2G (GSM/CDMA), 3G (UMTS/WCDMA), and emerging 4G (LTE) air interfaces, as well as indoor technologies such as Wi-Fi, DAS, and Femtocells, OmniLocate incorporates Polaris Wireless Location Signatures™ (Polaris WLS™) technology, which determines a mobile station's location by comparing radio measurements reported by the wireless device (or by a base station) against those in a comprehensive radio environment database. OmniLocate enables the ability to simultaneously locate all subscribers in a wireless network in real-time and on a historical basis.

Speaker recognition system 213 is a data-processing system that comprises hardware and software, and that is configured to perform the telecommunications functions and analysis operations according to the illustrative embodiment of the present invention. Speaker recognition system system 213, which is an element of wireless network 200, executes and coordinates the operations described herein in reference to method 500, including wherein speaker recognition system 213 communicates with other systems such as data store 214 and network probe unit 215, and also with external systems that are not part of wireless network 200, such as surveillance system 230. It will be clear to those having ordinary skill in the art, after reading the present disclosure, how to make and use alternative embodiments wherein speaker recognition system 213 communicates with elements of wireless network 200, but is not an element thereof.

Data store 214 is a digital data storage system that is responsible for receiving data, storing data, archiving data, and retrieving data in a fashion that is well-known in the art. Illustratively, data store 214 is implemented as a hard disk drive that is part of wireless network 200. Illustratively, data store 214 receives queries from speaker recognition system 213, retrieves appropriate responses to the queries, houses a database and receives/implements updates to the database, and also archives results along with other data as received from speaker recognition system 213. It will be clear to those having ordinary skill in the art, after reading the present disclosure, how to make and use alternative embodiments wherein data store 214 communicates with elements of wireless network 200, but is not an element thereof. It will be further clear to those having ordinary skill in the art, after reading the present disclosure, how to make and use alternative embodiments wherein data store 214 is part of speaker recognition system 213 and not a distinct element of wireless network 200.

Network probe unit 215, which is well known in the art, is a passive device that operates without disturbing or interfering with the ordinary operation of the wired connections that it taps or of the endpoints at the respective ends of those wired connections, e.g., base station 202-2 and wireless switching center 211. Network probe unit 215 taps a wired connection from base station 202-2 (or any base station 202-i or 203-j in wireless network 200) to extract voice signals and corresponding indentifying information as they travel to and from the base station; the extracted data is illustratively transmitted to speaker recognition system 213 for further processing and analysis.

Illustratively, data (both signaling and payload) that passes to and from base station 202-2 comprises voice signals and corresponding identifiers for the wireless voice calls that are served by base station 202-2. For example, when base station 202-2 is the serving base station for mobile station 201, all voice signals and corresponding control signaling (including identifiers) for those voice signals to and from mobile station 201 pass through base station 202-2 and are therefore detected and extracted by network probe unit 215 and transmitted to speaker recognition system 213 in a manner well known in the art. Illustratively, both a voice signal and an identifier of the mobile station from which it originated are tapped, extracted, and transmitted by network probe unit 215.

It will be clear to those having ordinary skill in the art, after reading the present disclosure, how to make and use alternative embodiments of the present invention using technologies other than network probe unit 215 to extract the voice signals and corresponding identifies to/from base station 202-2 (and any other base station, whether cellular or WiFi) in wireless network 200.

Telecommunications network 220 is well known in the art and provides connectivity and telecommunications (voice and/or data) among the systems that connect to it, including speaker recognition system 213, surveillance system 230, wireless switching center 211, etc.

Global Positioning System (“GPS”) constellation 221 is well known in the art and provides precise location data to GPS-enabled mobile stations and to any GPS-enabled system on Earth, including for example to a GPS tracking system (not shown) that telecommunicates with speaker recognition system 213, and/or to surveillance system 230.

Surveillance system 230 is a data-processing system that is illustratively used by a law-enforcement agency to keep lists of persons and mobile stations that are “of interest,” e.g., suspects, convicts, missing persons, etc. Surveillance system 230 transmits “of interest” data to speaker recognition system 213 and/or data store 214 to enable them to perform the functions according to the illustrative embodiment as described in further detail below. Furthermore, surveillance system 230 also receives transmissions from speaker recognition system 213 and other elements of wireless network 200 according to the illustrative embodiment. It will be clear to those having ordinary skill in the art, after reading the present disclosure, how to make and build alternative embodiments of the present invention wherein surveillance system 230 is differently connected and configured with respect to speaker recognition system 213, or is combined with speaker recognition system 213, whether as an element of wireless network 200 or not.

It will be clear to those having ordinary skill in the art, after reading the present disclosure, how to make and use alternative embodiments wherein speaker recognition system 213 and/or data store 214 is incorporated into one of the other illustrated systems, e.g., location system 212, or wireless switching center 211, or surveillance system 230. It will be further clear to those having ordinary skill in the art, after reading the present disclosure, how to make and use alternative embodiments wherein speaker recognition system 213 further comprises one or more of the other illustrated systems, e.g., location system 212 and/or wireless switching center 211 and/or data store 214 and/or network probe unit 215. It will be further clear to those having ordinary skill in the art, after reading the present disclosure, how to make and use alternative embodiments wherein speaker recognition system 213 telecommunicates directly with one or more external systems without the intervening services of telecommunications network 220.

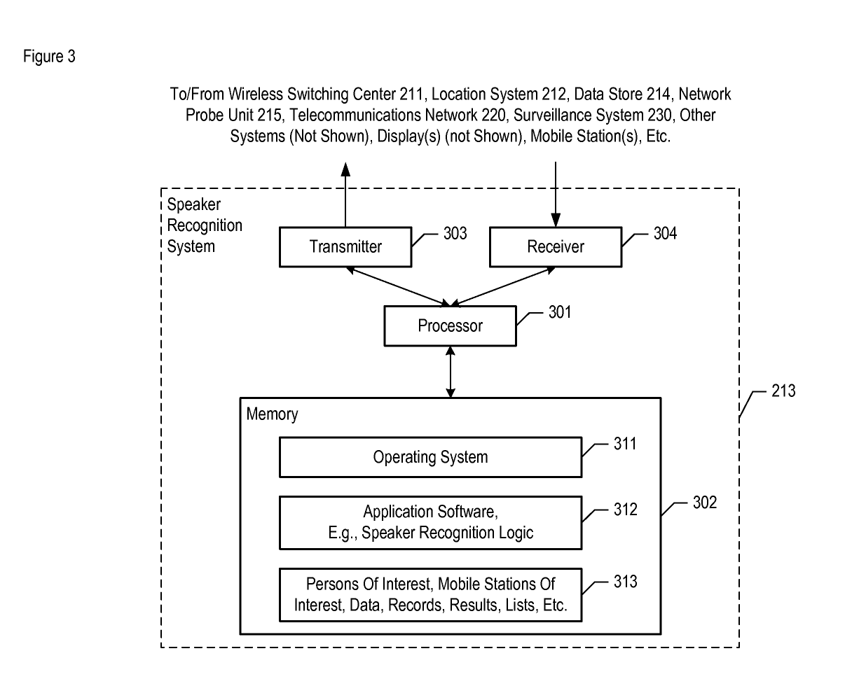

FIG. 3 depicts a block diagram of the salient components of speaker recognition system 213 in accordance with the illustrative embodiment. Speaker recognition system 213 is a data-processing system that comprises as part of its hardware platform: processor 301, memory 302, and transmitter 303 and receiver 304.

Processor 301 is a processing device such as a microprocessor that is well known in the art. Processor 301 is configured such that, when operating in conjunction with the other components of illustrative embodiment 213, processor 301 executes the software, processes data, and telecommunicates according to the operations described herein.

Memory 302 is non-transitory and non-volatile computer memory technology that is well known in the art. Memory 302 stores operating system 311, application software 312, and element 313 which comprises data, records, results, lists, etc. The specialized application software 312 that is executed by processor 301 is illustratively denominated the “speaker recognition logic” that enables speaker recognition system 213 to perform the operations of method 500. Memory element 313 illustratively comprises the “Persons of Interest” and the “Mobile Stations of Interest” information that is used according to the illustrative embodiment as described in more detail below. It will be clear to those having ordinary skill in the art how to make and use alternative embodiments that comprise more than one memory 302; or comprise subdivided segments of memory 302; or comprise a plurality of memory technologies that collectively store operating system 311, application software 312, and element 313.

Transmitter 303 is a component that enables illustrative embodiment 213 to telecommunicate with other components internal and external to wireless network 200 by transmitting signals thereto. For example, transceiver 303 enables telecommunication pathways to wireless switching center 211, location system 212, data store 214, etc. within wireless network 200, as well as to other systems that are external to wireless network 200, such as telecommunications network 220, surveillance system 230, etc., without limitation. Transmitter 303 is well known in the art. It will be clear to those having ordinary skill in the art how to make and use alternative embodiments that comprise more than one transmitter 303.

Receiver 304 is a component that enables illustrative embodiment 213 to telecommunicate with other components internal and external to wireless network 200 by receiving signals therefrom. For example, receiver 304 enables telecommunication pathways from wireless switching center 211, location system 212, data store 214, etc. within wireless network 200, as well as from other systems that are external to wireless network 200, such as telecommunications network 220, surveillance system 230, etc., without limitation. Receiver 304 is well known in the art. It will be clear to those having ordinary skill in the art how to make and use alternative embodiments that comprise more than one receiver 304.

It will be clear to those skilled in the art, after reading the present disclosure, that in alternative embodiments the data-processing hardware platform of speaker recognition system 213 can be embodied as a multi-processor platform, as a server, as a sub-component of a larger computing platform, or in some other computing environment—all within the scope of the present invention. It will be clear to those skilled in the art, after reading the present disclosure, how to make and use the data-processing hardware platform for speaker recognition system 213.

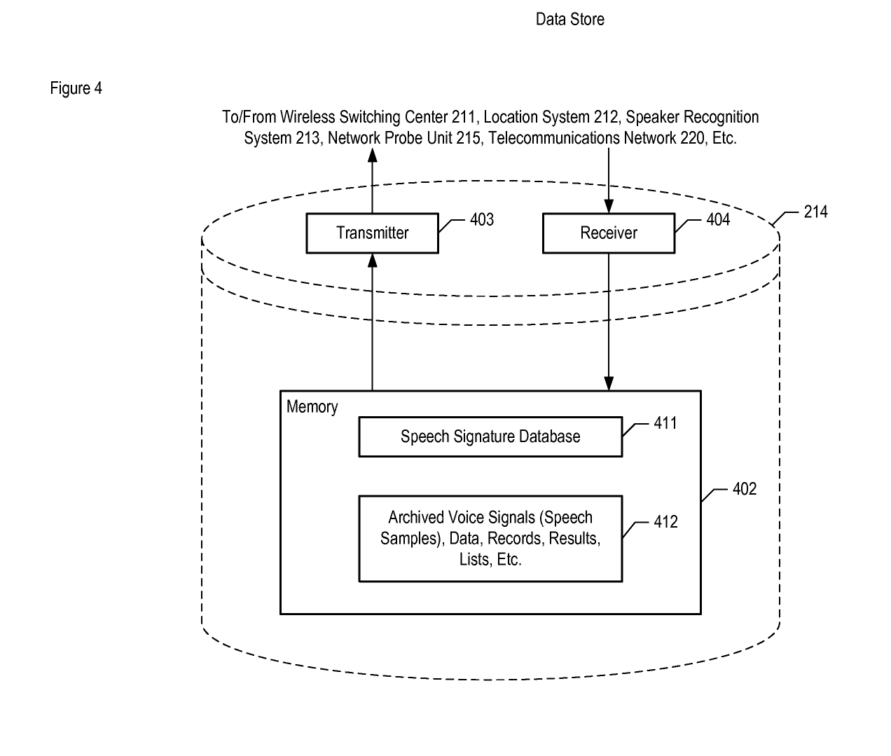

FIG. 4 depicts a block diagram of the salient components of data store 214 in accordance with the illustrative embodiment. Data store 214 is illustratively a digital data storage system that comprises as part of its hardware platform: memory 402, transmitter 403, and receiver 404. Illustratively, data store 214 is implemented as a hard disk drive that is part of wireless network 200.

Memory 402 is non-transitory and non-volatile computer memory technology that is well known in the art. Memory 402 stores speech signature database 411 and element 412 which comprises archived voice signals, data, records, results, lists, etc. It will be clear to those having ordinary skill in the art how to make and use alternative embodiments that comprise more than one memory 402; or comprise subdivided segments of memory 402; or comprise a plurality of memory technologies that collectively store speech signature database 411 (e.g., a distributed database) and memory element 412.

Transmitter 403 is a component that, analogous to transmitter 303, enables data store 214 to telecommunicate with other components internal and external to wireless network 200 by transmitting signals thereto.

Receiver 404 is a component that, analogous to transmitter 304, enables data store 214 to telecommunicate with other components internal and external to wireless network 200 by receiving signals therefrom.

It will be clear to those having ordinary skill in the art, after reading the present disclosure, how to make and use alternative embodiments wherein speech signature database 411 resides in whole or in part or in distributed form in surveillance system 230 and/or in speaker recognition system 213, and resides in data store 214 only in part or as a back-up. It will be further clear, after reading the present disclosure, how to make and use other alternative embodiments wherein speech signature database 411 does not reside in data store 214. It will be clear to those skilled in the art, after reading the present disclosure, how to make and use the hardware platform for data store 214.

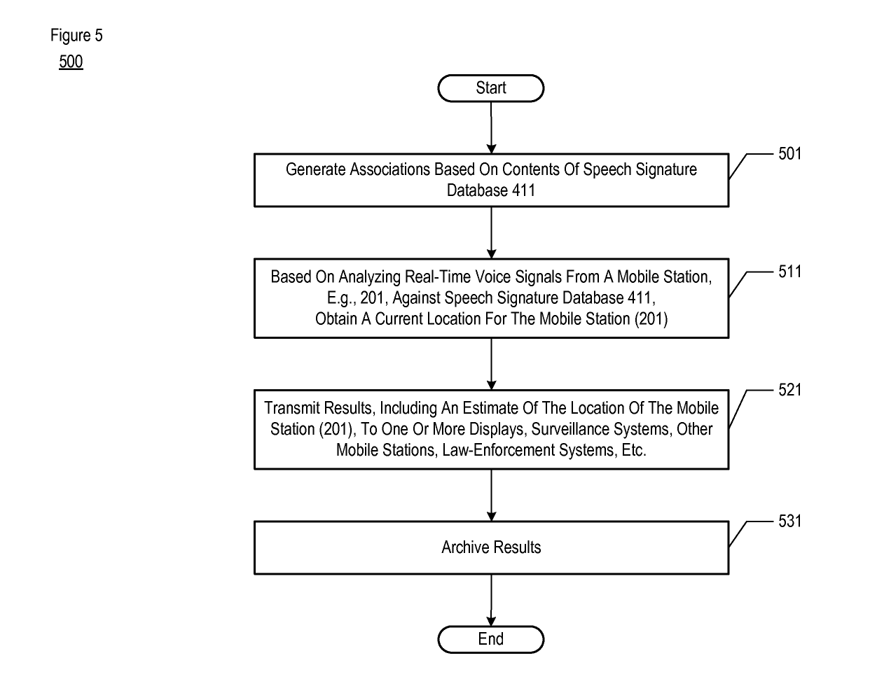

FIG. 5 depicts a flowchart of the salient operations of method 500 according to the illustrative embodiment of the present invention. Speaker recognition system 213 executes and coordinates the operations of method 500 in accordance with the illustrative speaker recognition logic.

At operation 501, speaker recognition system 213 generates associations based on the contents of speech signature database 411. Operation 501 is described in more detail in a subsequent figure.

At operation 511, speaker recognition system 213, based on analyzing one or more real-time voice signals from a mobile station against speech signature database 411, obtains a current location estimate for the mobile station, e.g., by requesting a current location from wireless location system 212. Operation 511 is described in more detail in a subsequent figure.

At operation 521, speaker recognition system 213 transmits results, including an estimate of the location of the mobile station, to one or more other systems and/or components, for example to one or more displays, surveillance systems, other mobile stations, law-enforcement systems, etc. According to the illustrative embodiment, when it receives an estimated location for a mobile station from wireless location system 212, speaker recognition system 213 transmits the location information to surveillance system 230 where it is displayed to an operator. The location information is accompanied by identification information about the mobile station (e.g., IMSI, telephone number) and identification information about the user of the mobile station (e.g., name, alias) so that the operator can take appropriate action, such as dispatching a rescue team, an anti-terrorist team, a police squad, etc.

It will be clear to those having ordinary skill in the art, after reading the present disclosure, how to make and use alternative embodiments wherein speaker recognition system 213 transmits a different set of results, or additional information, or transmits results to one or more different destinations, etc. without limitation.

At operation 531, speaker recognition system 213 archives results. According to the illustrative embodiment, speaker recognition system 213 transmits all information to be archived to data store 214 and memory element 412. Illustratively, speaker recognition system 213 archives: every voice signal that results in an update to speech signature database 411 (to be discussed in further detail below); every indication of a match as between a speech signature of an incoming voice signal and an existing speech signature in speech signature database 411; every association identified and retrieved as a result of the indication; every estimate received of the location of the mobile station; etc. Any and all information involved in performing method 500 may be archived according to the present operation and the details will be chosen by the implementers of an embodiment of the present invention.

It will be clear to those having ordinary skill in the art, after reading the present disclosure, how to make and use alternative embodiments wherein speaker recognition system 213 archives results to a destination other than data store 214, e.g., to a data structure internal to speaker recognition system 213, a data store external to wireless network 200, etc.

In regard to method 500, it will be clear to those having ordinary skill in the art, after reading the present disclosure, how to make and use alternative embodiments of method 500 wherein the operations and sub-operations are differently sequenced, grouped, or sub-divided—all within the scope of the present invention. It will be further clear to those skilled in the art, after reading the present disclosure, how to make and use alternative embodiments of method 500 wherein some of the recited operations and sub-operations are omitted or are executed by other elements of wireless network 200 and/or by systems that are external to wireless network 200.

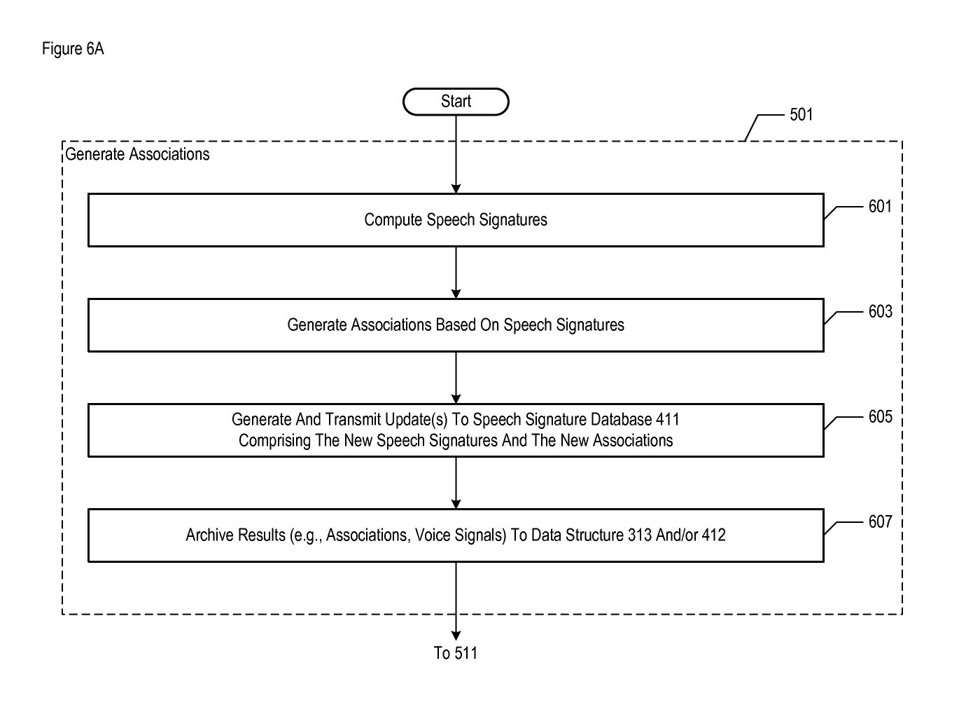

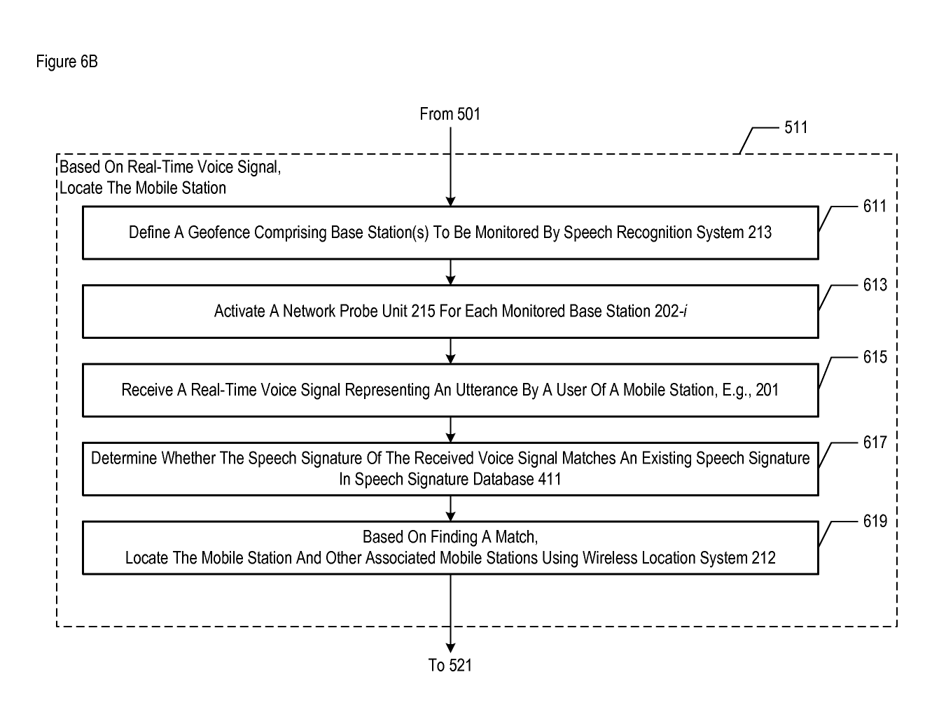

FIG. 6A depicts a flowchart of the salient sub-operations of operation 501 according to the illustrative embodiment of the present invention. Operation 501 is generally directed at generating associations.

At operation 601, speaker recognition system 213 computes speech signatures as described in more detail in a subsequent figure. Control passes to operation 603.

At operation 603, speaker recognition system 213 generates one or more associations based on the speech signatures computed in the preceding operation as well as based on the speech signatures in speech signature database 411, as described in more detail in a subsequent figure. Control passes to operation 605.

At operation 605, speaker recognition system 213 generates and transmits one or more updates to speech signature database 411, the updates comprising newly computed speech signatures and newly created associations, which resulted from the preceding operations.

According to the illustrative embodiment of the present operation, when a new speech signature is computed that does not exist in speech signature database 411 (e.g., operation 805), speaker recognition system 213 generates an update message (or messages) to transmit the new speech signature to data store 214 for update into speech signature database 411. Accordingly, in a kind of learning process, speech signature database 411 incorporates new speech signatures that it previously did not comprise. Likewise, according to the illustrative embodiment, when a new association results from the preceding operations (e.g., operation 801, 803, 807, 809), speaker recognition system 213 generates an update message (or messages) to transmit the newly generated information to data store 214 for update into speech signature database 411.

The update process according to the present operation provides speech database 411 and, by extension, speaker recognition system 213, with a substantial advantage over the prior art, because the enhancement of speech signature database 411 with newly-generated associations greatly enriches the amount of information that is available to the consumers of the database in later stages, e.g., operation 1005, operation 1015. Thus, the new speech signatures and newly-generated associations, as updated into speech signature database 411 according to the present operation, provide a much enhanced body of inferences and knowledge that is available for further analysis, such as when location requests arise. Any and all information involved in performing the preceding operations may be used to generate appropriate updates for speech signature database 411, and the details will be chosen by the implementers of an embodiment of the present invention, after reading the present disclosure. It will be clear to those having ordinary skill in the art how to transmit the updates to speech signature database 411.

At operation 607, speaker recognition system 213 archives results, e.g., newly-generated associations, voice signals (e.g., raw, decompressed, decrypted), to one or more data structures in memory element 313 and/or data structures in memory element 412. The details of which information to archive will be chosen by the implementers of an embodiment of the present invention, with additional reference to operation 531.

FIG. 6B depicts a flowchart of the salient sub-operations of operation 511 according to the illustrative embodiment of the present invention. Operation 511 is generally directed at obtaining an estimated location for the mobile station that originated the recognized voice signal.

At operation 611, speaker recognition system 213 logically defines and activates a geofence that comprises one or more base stations within wireless network 200 that are to be monitored by speaker recognition system 213. Illustratively, the geofence comprises the base stations that cover a particular city, but excludes the base stations that cover the surrounding areas and other more remote areas. This operation is optional, but is desirable when the real-time processing of all voice signals within wireless network 200 is computationally burdensome or prohibitive. This operation is also desirable when the given geographic area within the geofence is of particular interest, e.g., Capitol Hill and the White House in Washington, D.C., while other neighboring geographic areas are of less interest and can distract investigators. The scope of the geofence is left to the implementers. Defining and activating a geofence according to the present operation is well known in the art.

At operation 613, a network probe unit 215 is activated for each of the monitored base stations within the geofence. Installing, activating, and operating a network probe unit 215 is well known in the art. According to the illustrative embodiment, speaker recognition system 213 logically activates reception of data from network probe unit 215 according to the geofence, illustratively monitoring communications to and from base station 202-2 (separate network probe units might be required to monitor the uplink and the downlink from/to each respective base station, as one skilled in the art understands).

At operation 615, speaker recognition system 213 receives a real-time voice signal from network probe unit 215 in a manner well known in the art. The voice signal represents an utterance made by the user of a mobile station that is served by base station 202-2. The voice signal is designated as “real-time” because it is transmitted to speaker recognition system 213 in real-time, as the conversation occurs, in order to enable locating the mobile station and its user. Illustratively, the voice signal represents an utterance by the user of mobile station 201, designated for convenience here as “user-201.” The voice signal is received along with identifying information that indicates the identity of the mobile station from which the voice signal is received, e.g., “<voice signal> from mobile station 201”.

When the voice signal is traveling downlink to the monitored base station, meaning that it originated from a station that is communicating with a mobile station being served by the monitored base station, but which is not itself being monitored, a person having ordinary skill in the art will know how to find the identity of the unmonitored station. Although the illustrative embodiment generally is directed at locating mobile stations being served by the monitored base stations (i.e., within the geofence), it will be clear to those having ordinary skill in the art, after reading the present disclosure, how to make and use alternative embodiments that also identify and locate stations (mobile or fixed) that communicate downlink via a monitored base station. For example, the originating mobile station might be in a neighboring unmonitored geographical area, perhaps moving towards the geofenced monitored area. Locating a person of interest who is adjacent to a monitored geofence may be supported according to alternative embodiments.

At operation 617, speaker recognition system 213 analyzes the received (monitored) voice signal to determine whether the voice signal's speech signature matches one or more existing speech signatures in speech signature database 411. This operation is described in more detail in a subsequent figure.

At operation 619, based on finding a speech signature match in the preceding operation, speaker recognition system 213 locates the mobile station that originated the voice signal and also locates one or more other associated mobile stations using the functionality of wireless location system 212. This operation leverages the information and associations populated into speech signature database 411 earlier (see, e.g., operation 605) to locate not only the mobile station that originated the recognized voice signal, i.e., mobile station 201, but to also locate other associated mobile stations, for example mobile stations that were previously used by user-201 and that possibly are carried by accomplices of user-201—accomplices whose speech signatures are unknown or who are currently silent. The present operation is described in more detail in subsequent figures.

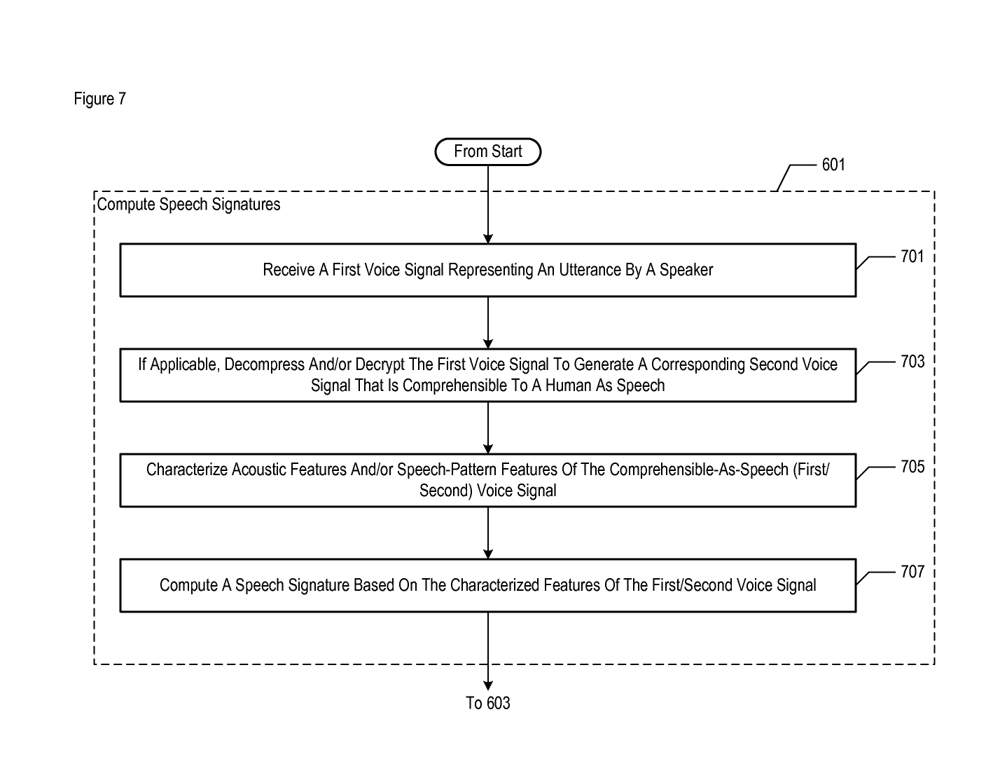

FIG. 7 depicts a flowchart of the salient sub-operations of operation 601 according to the illustrative embodiment of the present invention. Operation 601 is generally directed at computing speech signatures.

At operation 701, in a manner well known in the art, speaker recognition system 213 receives a first voice signal representing an utterance by a user who is using a mobile station, e.g., mobile station 201, or a wired station. Illustratively, the voice signal is received via network probe unit 215, which is probing communications to/from base station 202-2.

At operation 703, speaker recognition system 213 analyzes the first voice signal to determine whether it is compressed and/or encrypted; if so, speaker recognition system 213 decompresses and/or decrypts the first voice signal to generate a second voice signal that is comprehensible to a human as speech. This operation is well known in the art. The resulting voice signal is comprehensible to a human as speech and therefore can be further processed according to the illustrative embodiment.

At operation 705, according to techniques that are well known in the art, speaker recognition system 213 performs one or more operations that characterize the acoustic features and/or speech-pattern features of the voice signal that is comprehensible to a human as speech, i.e., characterizing the result of the preceding operation. There are numerous techniques for characterizing speech, for example, as referenced in U.S. Pat. No. 5,897,616 (to Kanevsky et al.), or U.S. Pat. No. 6,356,868 B1 (to Yuschik et al.). The techniques and characteristics are to be chosen by the implementers of an embodiment of the present invention.

At operation 707, according to techniques that are well known in the art, speaker recognition system 213 computes a speech signature that is based on the characterized features computed in the preceding operation. The speech signature is intended to uniquely identify the speaker according to the one or more characterized features, e.g., acoustics, gender, speech rate, accent, preferred vocabulary, etc.

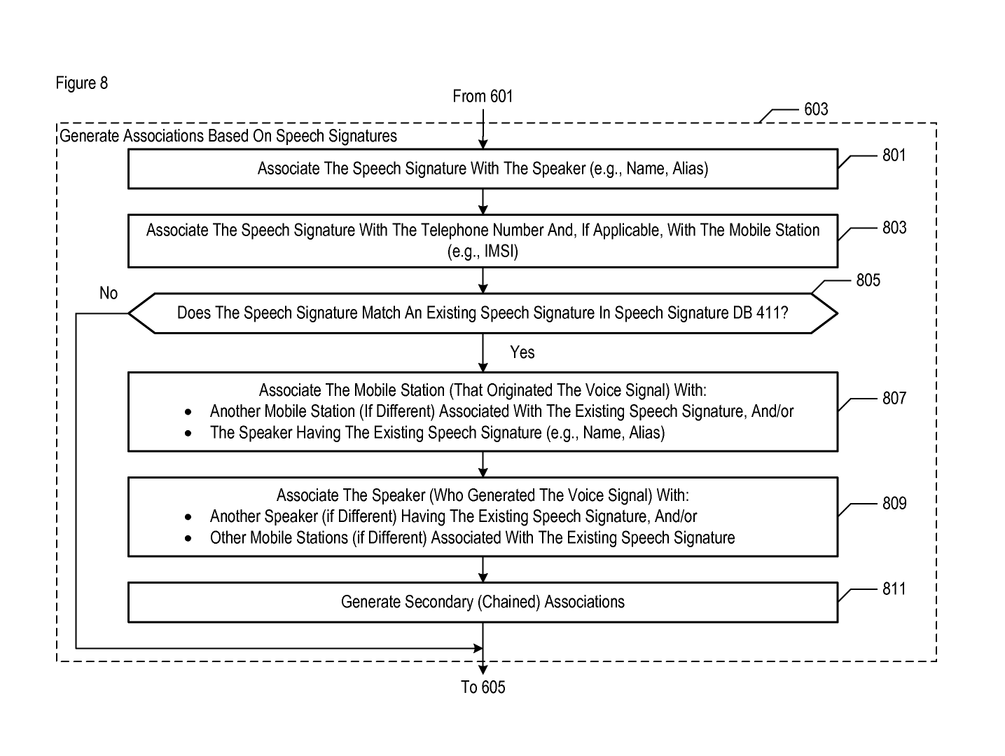

FIG. 8 depicts a flowchart of the salient sub-operations of operation 603 according to the illustrative embodiment of the present invention. Operation 603 is generally directed at generating associations based on speech signatures.

At operation 801, speaker recognition system 213 generates an association between the incoming speech signature computed in operation 707 and the available identity (or identities) of the user who made the utterance, such as the user's name or alias or another identifying indicium, e.g., user-201.

At operation 803, speaker recognition system 213 generates an association between the incoming speech signature computed in operation 707 and the available identity (or identities) of the mobile station from which the voice signal was received, for example, the international Mobile Subscriber Identifier (“IMSI”), the telephone number assigned to the mobile station, or another identifying indicium provided by wireless network 200.

At operation 805, which is a decision point, speaker recognition system 213 determines, according to techniques that are well known in the art, whether the speech signature matches an existing speech signature in speech signature database 411. See, e.g., U.S. Pat. No. 5,897,616 (to Kanevsky et al.); U.S. Pat. No. 6,356,868 B1 (to Yuschik et al.). Often a comparator function compares the characterized features and measures a correlation; when the measure of correlation exceeds a threshold, speaker recognition system 213 determines that a match has been found. When speaker recognition system 213 does not find a match, control passes out of operation 603 to operation 605. When speaker recognition system 213 finds a match, control passes to operation 807.

At operation 807, speaker recognition system 213 generates more associations, including but not limited to:
Generating an association between the mobile station that originated the voice signal (e.g., 201) and another mobile station (if different) that is also associated with the present speech signature; for example, if the matching speech signature in speech database 411 is currently associated with mobile station 210, the present operation additionally generates an association between mobile station 201 and mobile station 210; this association tends to indicate that the same speaker used both mobile stations 201 and 210; and
Generating an association between the mobile station that originated the voice signal and an identifier of the speaker with the existing (matching) speech signature in speech signature database 411; for example, if the matching speech signature in speech database 411 is currently associated with a speaker known as “Sam,” the present operation additionally generates an association between mobile station 201 and speaker Sam.

At operation 809, speaker recognition system 213 generates more associations, including but not limited to:
Generating an association between the user of the mobile station (whose utterance is represented by the voice signal), e.g., user-201, and the speaker with the existing (matching) speech signature in speech signature database 411, e.g., Sam; continuing from the example above, for example, the present operation additionally generates an association between user-201 and Sam, suggesting that user-201 is Sam; and
Generating an association between the user of the mobile station, e.g., user-201, and other mobile stations (if different from the user's mobile station 201) that are currently associated with the matching speech signature in speech signature database 411, e.g., mobile station 210; thus, the present operation additionally generates an association between user-201 and mobile station 210 based on having recognized user-201's speech signature.

The result of all the associations generated by speaker recognition system 213 in operation 603 comprises, illustratively, the following pairwise associations:
Incoming speech signature—user-201
Incoming speech signature—mobile station 201
Incoming speech signature—telephone number 123-456-7890
Mobile station 201—mobile station 210
Mobile station 201—Sam
User-201—Sam
User-201—mobile station 210

At operation 811, speaker recognition system 213 generates further secondary associations through chaining. For example, other associations result here, e.g., an association between the matching (existing) speech signature and the mobile station, e.g., 201—a station that was previously not associated with that speech signature. One speech signature could be associated with many different mobile stations, for example, resulting in mutual associations as between those mobile stations. The web of interconnecting associations that can be devised from the illustrative examples based on the operations described herein are omitted here for simplicity, but can be determined by a person having ordinary skill in the art after reading the present disclosure. As noted, this web of interconnecting associations provides a marked advantage to speaker recognition system 213 when seeking to locate a mobile station with a recognized speech signature. At the conclusion of operation 603, control passes to operation 605.

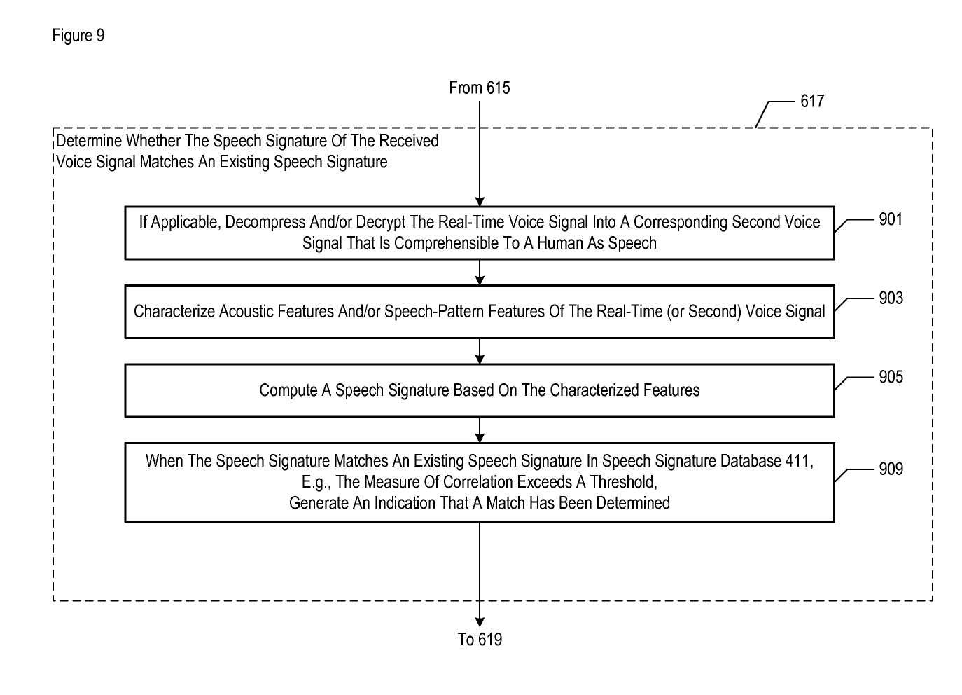

FIG. 9 depicts a flowchart of the salient sub-operations of operation 617 according to the illustrative embodiment of the present invention. Operation 617 is generally directed at determining whether the (incoming) speech signature of the received voice signal matches an existing speech signature in speech database 411. In contrast to operation 805 which contributes to building and enhancing the database, the present operation is directed towards recognizing a user of a mobile station in real-time in order to enable locating the mobile station based on recognizing the user's speech signature.

At operation 901, speaker recognition system 213 decompresses and/or decrypts the real-time voice signal, if applicable, into a corresponding voice signal that is comprehensible to a human as speech, in a manner analogous to operation 703 described above.

At operation 903, speaker recognition system 213 characterizes acoustic features and speech-pattern features of the comprehensible-as-speech voice signal in a manner analogous to operation 705 described above.

At operation 905, speaker recognition system 213 computes the incoming speech signature (from mobile station 201) in a manner analogous to operation 707 described above.

At operation 909, speaker recognition system 213 determines, according to techniques that are well known in the art, whether the incoming speech signature (from mobile station 201) matches an existing speech signature in speech signature database 411, in a manner analogous to operation 805. For example, speaker recognition system 213 takes a measure of correlation between the incoming speech signature and speech signatures in database 411, and a match is determined when the measure of correlation passes a certain threshold. When it finds a match, speaker recognition system 213 accordingly generates an indication that a match has been determined to exist. At the conclusion of operation 617, control passes to operation 619.

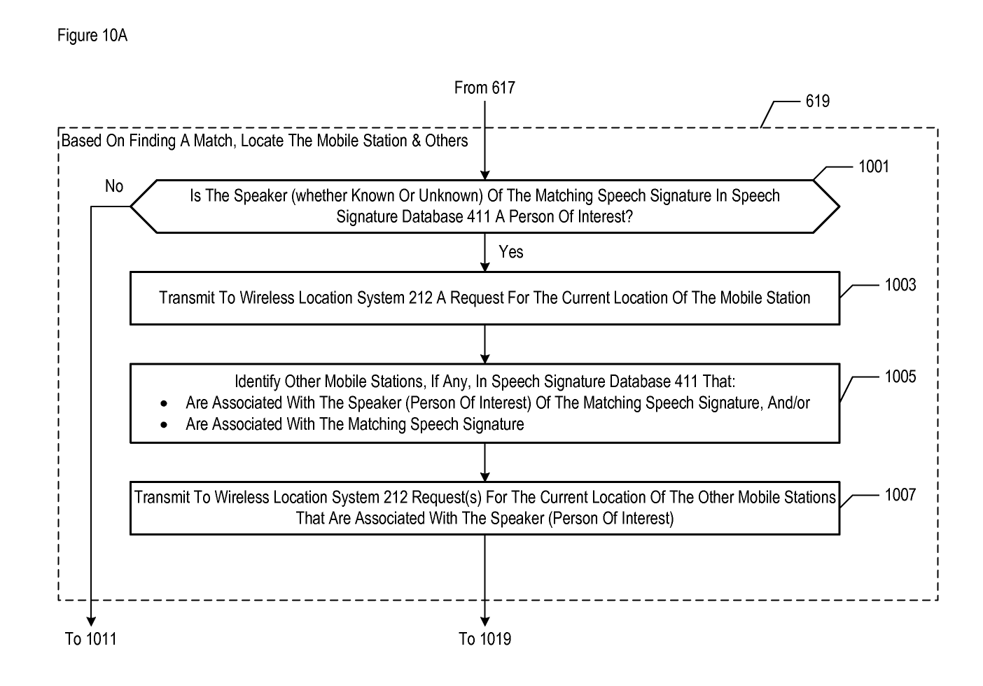

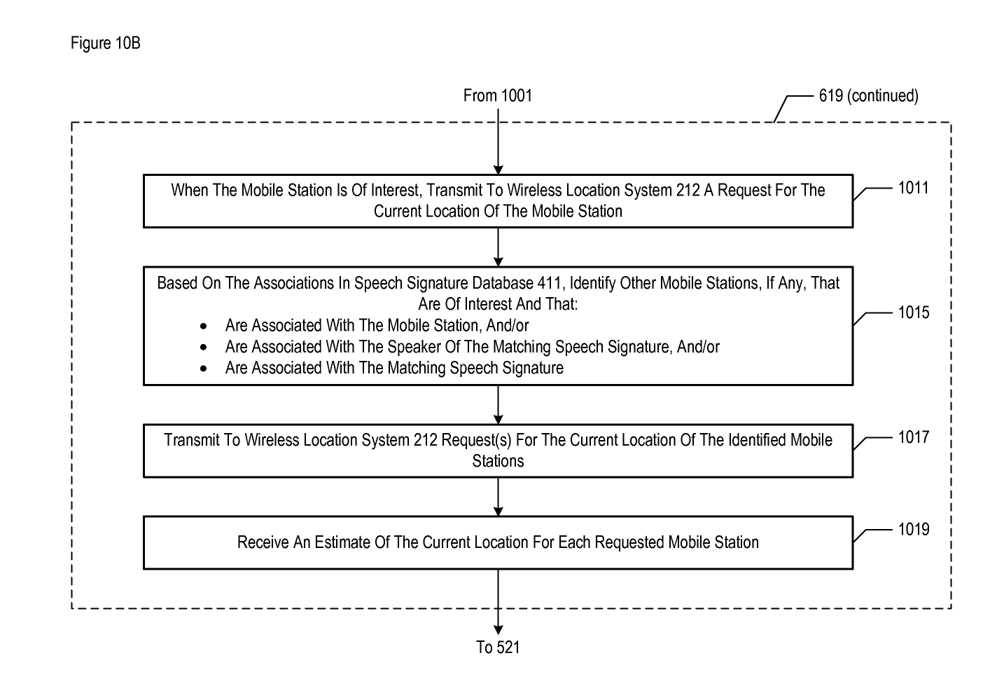

FIG. 10A depicts a flowchart of the salient sub-operations of a first part of operation 619 according to the illustrative embodiment of the present invention. Operation 619 is generally directed to locating the active mobile station and other associated mobile stations based on a speech signature match found in the preceding operation.

At operation 1001, which is a decision point, speaker recognition system 213 determines whether the identity of the speaker of the matching (existing) speech signature is a person of interest, i.e., whether Sam is a person of interest. To make this determination, speaker recognition system 213 checks one or more sources of “persons of interest” information in memory element 313 and/or in surveillance system 230. When several speaker identifiers are associated with the matching (existing) speech signature in speech signature database 411, all are checked against the persons of interest information, e.g., Sam, “Sam-I-Am,” and “S._Lastname,” all of which are associated with the same speech signature in database 411. When none of these identities are identified to be a person of interest, control passes to operation 1011, but when one or more of them is of interest, control passes to operation 1003.

At operation 1003, speaker recognition system 213 transmits to wireless location system 212 a request for a current location of the mobile station where the recognized voice signal originated, e.g., mobile station 201.

At operation 1005, speaker recognition system 213 searches speech signature database 411 for additional associations to identify other mobile stations (different from 201) that:
are associated with the speaker (who is the person of interest) of the matching speech signature, e.g., other mobile stations associated with Sam, and/or
are associated with the matching (existing) speech signature, e.g., mobile station 210 being associated with mobile station 201.

At operation 1007, speaker recognition system 213 transmits to wireless location system 212 request(s) for a current location of the identified associated mobile stations, e.g., mobile station 210. Control passes to operation 1019.

FIG. 10B depicts a flowchart of the salient sub-operations of a second part of operation 619 according to the illustrative embodiment of the present invention. The present sub-operations continue from the preceding figure.

At operation 1011, speaker recognition system 213 determines that the active mobile station originating the voice signal is “of interest” in a manner analogous to operation 1001. When one or more of the mobile station identifiers (e.g., IMSI, telephone number, etc.) are of interest, speaker recognition system 213 transmits to wireless location system 212 a request for a current location of the mobile station, e.g., 201. Illustratively, the telephone number of mobile station 201, e.g., 123-456-7890, is of interest and therefore a location request for mobile station 201 is transmitted by speaker recognition system 213.

At operation 1015, based on the associations stored in speech signature database 411, speaker recognition system 213 identifies other mobile stations (or SIM cards with a different IMSI), if any, that are of interest and that:
are associated with the mobile station of interest that originated the recognized voice signal, e.g., mobile station 210 being associated with mobile station 201, and/or
are associated with the speaker of the matching (existing) speech signature, e.g., other mobile stations associated with Sam; and/or
are associated with the matching (existing) speech signature.

At operation 1017, speaker recognition system 213 transmits to wireless location system 212 request(s) for a current location of the identified associated mobile stations from the preceding operation, e.g., mobile station 210.

At operation 1019, speaker recognition system 213 receives from wireless location system 212 an estimate of the location for each requested mobile station, e.g., 201 and 210. The estimate of the location is well known in the art.

At the conclusion of operation 619 control passes to operation 521.

It is to be understood that the present disclosure teaches just one example of the illustrative embodiment and that many variations of the invention can easily be devised by those skilled in the art after reading this disclosure. The scope of the present invention is to be determined by the following claims.

What is claimed is:

1. A method comprising:
when a first measure of correlation as between (i) a first speech signature of a first voice signal from a first mobile station and (ii) a second speech signature of a second voice signal exceeds a first threshold, generating, by a speaker-recognition system, an association between the first mobile station and a second mobile station that is associated with the second speech signature, wherein the first mobile station is different from the second mobile station.

2. The method of claim 1 further comprising:
based on the measure of correlation exceeding the first threshold, generating, by the speaker-recognition system, an association between the first mobile station and a speaker having the second speech signature.

3. The method of claim 1 further comprising:
based on the measure of correlation exceeding the first threshold, generating, by the speaker-recognition system, an association between a first user of the first mobile station and at least one of:
(A) a speaker having the second speech signature, and
(B) the second mobile station.

4. The method of claim 1 further comprising:
based on the measure of correlation exceeding the first threshold, generating, by the speaker-recognition system, an association between a telephone number associated with the first mobile station and the second speech signature.

5. The method of claim 1 wherein a speech signature database comprises the second speech signature, and further comprising:
receiving, by the speaker-recognition system, the first voice signal;
computing, by the speaker-recognition system, the first speech signature based on the first voice signal; and
transmitting, by the speaker-recognition system, an update to the speech signature database, the update comprising the association between the first mobile station and the second mobile station.

6. The method of claim 1 wherein the first mobile station is identified by an International Mobile Subscriber Identifier that is associated with a subscriber identity module in the first mobile station.

7. A system comprising:
a receiver for receiving a first voice signal from a first mobile station; and
a processor configured to:
determine whether a first speech signature of the first voice signal matches a second speech signature of a second voice signal,
when the first speech signature matches the second speech signature, generate at least one of:
(I) an association between the first mobile station and a second mobile station that is associated with the second speech signature, wherein the first mobile station is different from the second mobile station,
(ii) an association between the first mobile station and a speaker having the second speech signature,
(iii) an association between a first user of the first mobile station and the speaker having the second speech signature,
(iv) an association between the first user of the first mobile station and the second mobile station, and
(v) an association between a telephone number associated with the first mobile station and the second speech signature.

8. The system of claim 7 further comprising:
a transmitter configured to transmit an update to a speech signature database, the update comprising at least one association generated by the processor.

9. The system of claim 7 wherein the processor is further configured to:
compute the first speech signature based on the first voice signal.

10. A method comprising:
computing, by a speaker-recognition system, a first speech signature of a first voice signal from a first mobile station; and
when the first speech signature matches a second speech signature of a second voice signal, transmitting, by the speaker-recognition system, a request for a location of the first mobile station.

11. The method of claim 10 further comprising:
receiving, by the speaker-recognition system, the first voice signal from the first mobile station, wherein the first voice signal represents an utterance by a first user of the first mobile station;
comparing, by the speaker-recognition system, the first speech signature to the second speech signature to determine whether a measure of correlation therebetween exceeds a first threshold; and
when the threshold is exceeded, determining by the speaker-recognition system that the first speech signature matches the second speech signature.

12. The method of claim 10 further comprising:
receiving by the speaker-recognition system an estimate of the location of the first mobile station in response to the request for the location.

13. The method of claim 10 further comprising:
based on the match, identifying, by the speaker-recognition system, whether a second mobile station that is different from the first mobile station is associated with the second speech signature; and
when the second mobile station is associated with the second speech signature, transmitting, by the speaker-recognition system, a request for a location of the second mobile station.

14. The method of claim 13 wherein a speech signature database comprises:
(A) the second speech signature, and
(B) the association between the second mobile station and the second speech signature.

15. The method of claim 10 further comprising:
based on the match, identifying, by the speaker-recognition system, a second speaker who is associated with the first mobile station;
identifying, by the speaker-recognition system, a second mobile station that is associated with the second speaker; and
transmitting, by the speaker-recognition system, a request for a location of the second mobile station.

16. The method of claim 10 wherein the transmitting of the request for the location of the first mobile station is also based on whether a first user of the first mobile station is of interest.

17. The method of claim 10 wherein the transmitting of the request for the location of the first mobile station is also based on whether the first mobile station is of interest.

18. The method of claim 10 wherein the transmitting of the request for the location of the first mobile station is also based on whether a telephone number that is associated with the second speech signature is of interest.

19. The method of claim 10 wherein the transmitting of the request for the location of the first mobile station is also based on whether a telephone number that is associated with the first mobile station is of interest.

20. A system comprising:
a processor configured to:
compute a first speech signature of a first voice signal from a first mobile station, and
when the first speech signature matches a second speech signature of a second voice signal, generate a request for a location of the first mobile; and
a transmitter configured to transmit the request for a location of the first mobile station.

21. The system of claim 20 further comprising:
a receiver configured to receive the first voice signal from the first mobile station, wherein the first voice signal represents an utterance by a first user of the first mobile station; and
wherein the processor is further configured to:
compare the first speech signature to the second speech signature to determine whether a measure of correlation therebetween exceeds a first threshold, and
when the threshold is exceeded, determine that the first speech signature matches the second speech signature.

22. The system of claim 20 further comprising:
a receiver configured to receive an estimate of the location of the first mobile station in response to the request for the location.

23. The system of claim 20 wherein the processor is further configured to:
based on the match, identify a second speaker who is associated with the first mobile station, and
identify a second mobile station that is associated with the second speaker; and
wherein the transmitter is further configured to transmit a request for a location of the second mobile station.

24. The system of claim 20 wherein the processor is further configured to generate the request for the location of the first mobile station based on at least one of:
(A) whether a first user of the first mobile station is of interest,
(B) whether the first mobile station is of interest,
(C) whether a telephone number that is associated with the second speech signature is of interest, and
(D) whether a telephone number that is associated with the first mobile station is of interest.

25. A method comprising:
receiving, by a speaker-recognition system, a first voice signal from a first mobile station, wherein the first voice signal represents an utterance by a first user of the first mobile station;
computing, by the speaker-recognition system, a first speech signature of the first user based on the first voice signal;
when a first measure of correlation as between (i) the first speech signature and (ii) a second speech signature of a second voice signal exceeds a first threshold, generating, by the speaker-recognition system, an indication that the first user is the same as a speaker having the second speech signature; and
based on the indication, transmitting, by the speaker-recognition system, a request for a location of the first mobile station.

26. The method of claim 25 further comprising:
receiving by the speaker-recognition system an estimate of the location of the first mobile station in response to the request for the location.

27. The method of claim 25 further comprising:
based on the indication, identifying, by the speaker-recognition system, whether a second mobile station that is different from the first mobile station is associated with the second speech signature; and
when a second mobile station is associated with the second speech signature, transmitting, by the speaker-recognition system, a request for a location of the second mobile station.
